(19) United States
(12) Patent Application Publication
(10) Pub. No.: US 2008/0224550 A1
(43) Pub. Date: Sep. 18, 2008

(54) Magnetic Motor

(76) Inventors: Sung Hee Hyun, Anyang-Si Gyeonggi-Do (KR); Jae Jo Kim, Anyang-Si Gyeonggi-do (KR); David Daeho Kim, Anyang-Si Gyeonggi-Do (KR)

Correspondence Address: IPLA P.A., 3580 WILSHIRE BLVD., 17TH FLOOR, LOS ANGELES, CA, 90010, US

(21) Appl. No.: 12/066,151

(22) PCT Filed: Dec. 30, 2005
(86) PCT No.: PCT/KR2005/004658

§ 371 Date: Mar. 7, 2008

(30) Foreign Application Priority Data
Sep. 8, 2005 (KR) 10-2005-0083645

(51) Int. Cl. H02K 1/12

(52) U.S. Cl. 310/46

(57) ABSTRACT

There is provided a magnetic motor which comprises a rotation assembly having a rotation axis and a plurality of rotating bodies fixedly installed at an interval along the rotation axis and magnetized to have multipole; one or more electromagnets, installed in a region influenced by a magnetic field derived from the adjacent rotating bodies, whereby the rotating assembly is driven by magnetic repulsive and attractive forces between the rotating bodies and the one or more electromagnets; and a controller for sequentially controlling magnetization of the electromagnets.

### TECHNICAL FIELD

The present invention relates to a magnetic motor; more particularly, to a magnetic motor capable of obtaining a driving force by using rotating bodies having a magnetic force and one or more electromagnets.

### BACKGROUND ART

In general, an electric motor obtains a driving force by an electromagnetic force generated when a current is applied. That is, such an electric motor is an electric power apparatus converting an electric energy to a mechanical energy.

The electric motor has a relatively high efficiency and a good controllability, and it is easy to handle. It can broadly be used wherever a power is available, and an output range is varied from a large value to a small value, and there are various types of the electric motors having different characteristics. Moreover, it is used for various purposes from a home use to an industrial use.

An operation principle of the electric motor is based on a classical electromagnetic force. That is, when a current perpendicular to a magnetic field flows in the magnetic field, a force is generated in a direction perpendicular to directions of the magnetic field and the current according to the Fleming's left hand law. In case the direction of the current changes in accordance with successive rotations so that a relative direction relation between the directions of the magnetic field and the current is constant, the generated force becomes a rotational force in a same direction around a central axis to continue a rotation in the same direction.

There are many kinds of the electric motors having different features and purposes such as: a DC brush motor using the Fleming's left hand law; a brushless DC motor (BLDC) having the same features as those of a brush-type motor in a manner that a field magnet is disposed on a rotor and an armature winding is disposed on a stator, and the direction of the current in a winding is determined by using a hall sensor and a photo diode; an induction motor having the same structure as that of a transformer separated into a primary side and a secondary side; a reluctance motor using a principle that speeds of a magnetic flux in an air and an iron are different by about 6000 times; a stepping motor; an ultrasonic motor; and a linear motor for a rectilinear movement.

### DISCLOSURE OF INVENTION

### Technical Problem

Although the electric motors have the various types and the many uses, they have disadvantages that an efficiency of an input energy is unsatisfactory, and installation structures of a brush and the like are complex so that a maintenance and a repair are required.

### Technical Solution

It is, therefore, an object of the present invention to provide a magnetic motor capable of generating a rotation torque with a high efficiency by help of a low power loss of an initial driving force.

It is another object of the present invention to provide a magnetic motor having a simple structure without a need for a brush.

In accordance with the present invention, there is provided a magnetic motor including: a rotation assembly having a rotation axis and a plurality of rotating bodies fixedly installed at an interval along the rotation axis and magnetized to have multipole; one or more electromagnets, installed in a region influenced by a magnetic field derived from the adjacent rotating bodies, whereby the rotating assembly is driven by magnetic repulsive and attractive forces between the rotating bodies and the one or more electromagnets; and a controller for sequentially controlling magnetization of the one or more electromagnets.

### ADVANTAGEOUS EFFECTS

In accordance with the magnetic motor apparatus of the present invention, a repulsive force is generated by magnetizing the one or more electromagnets between the rotating bodies fixed in a misaligned state. Accordingly, it can generate a rotation torque with a high efficiency due to the low power loss of the initial driving force. Further, it is durable and its application scope is wide due to a simple structure using magnetic rotating bodies and one or more electromagnets without a need for a brush.

Moreover, in accordance with the magnetic motor of the present invention, a maintenance and a repair are almost not needed, and a unit cost of a production is low.

### BRIEF DESCRIPTION OF THE DRAWINGS

The above and other objects and features of the present invention will become apparent from the following description of preferred embodiments given in conjunction with the accompanying drawings, in which:

FIG. 1 provides a perspective view of a magnetic motor in accordance with a first preferred embodiment of the present invention;

FIG. 2 shows a perspective view of a magnetic motor in accordance with a second preferred embodiment of the present invention;

FIG. 3 presents a perspective view of a magnetic motor in accordance with a third preferred embodiment of the present invention;

FIG. 4 sets forth a perspective view of a magnetic motor in accordance with a fourth preferred embodiment of the present invention;

FIGS. 5 to 7 depict flow diagrams showing an operation of the magnetic motor depicted in FIG. 1; and

FIG. 8 is a drawing showing an operation of the magnetic motor depicted in FIG. 2.

### BEST MODE FOR CARRYING OUT THE INVENTION

Hereinafter, the preferred embodiments of the present invention will be described in detail with reference to the accompanying drawings.

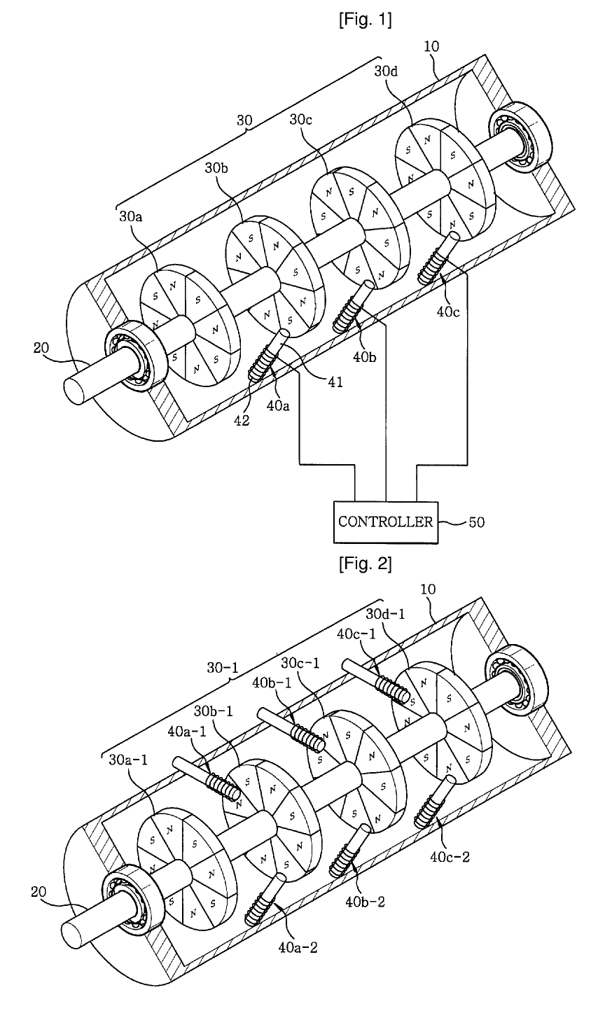

Referring to FIG. 1, there is provided a perspective view of a magnetic motor in accordance with a first preferred embodiment of the present invention.

As shown in FIG. 1, the magnetic motor includes generally a rotation assembly having a rotation axis 20 and a plurality of rotating bodies 30 fixedly installed along a direction of the rotation axis 20; one or more electromagnets 40 disposed between the rotating bodies 30; and a controller 50 controlling the one or more electromagnets 40.

The rotation axis 20 is rotatably installed at internal center portions of two end surfaces of a housing 10 through the medium of a bearing (not shown).

Two or more rotating bodies 30 are fixedly installed at an interval set by considering a rotational balance along the rotation axis (only four rotating bodies are exemplary shown in this drawing). Although there is shown in FIG. 1 that the rotating bodies are installed at constant intervals, it is preferable that they are arranged so that one or more electromagnets are disposed between two neighboring rotating bodies. While the rotating bodies 30a, 30b, 30c and 30d are disk-shaped, they may be plates which are ring-shaped, polygon-shaped, ellipse-shaped or saw tooth-shaped, or they may be zigzag shaped 3-dimensional structures or the like. Or the rotating bodies may be wing shaped to transfer or mix a solid, a liquid or a gas disposed around the rotation assembly in one direction in accordance with the rotation of the rotation assembly. Further, an arbitrary modification of the structure other than the shown ones may be made.

Further, each of the rotating bodies 30a, 30b, 30c and 30d is divided into a plurality of regions in a radial direction and each of the regions is magnetized to have either N or S poles in an alternative fashion or an intermittent fashion on an entire region or a partial region of the each of the rotating bodies, each region facing each other having opposite poles on adjacent rotating bodies. In accordance with the present embodiment, the poles, N and S, are alternately and repeatedly disposed in a circumferential direction. Although eight magnetic poles are formed in the illustrated case, two or more poles may be formed.

Each of these rotating bodies 30 are fixed along the rotation axis 20 with divided into a plurality of regions in a radial direction, wherein the regions at corresponding positions of the neighboring rotating bodies 30 are offset by a predetermined angle, to generate the component of the magnetic force in the circumferential direction from the magnetic force formed between the rotating bodies 30, wherein the poles of each of the rotating bodies 30 are disposed to face the opposite poles of the neighboring rotating bodies 30.

In case that the offset angle is 0, that is, in case that the poles of the rotating bodies 30 are disposed to exactly face the opposite poles of the neighboring rotating bodies 30, a direction of magnetic force lines is parallel to the rotation axis 20 in a positive or negative direction. On the contrary, if given the offset angle, the magnetic force lines have a circumferential component and an axis-parallel component, wherein the circumferential component of the magnetic force lines provides a rotational force when it overlaps with other magnetic force lines.

In this connection, in the rotating bodies 30 divided into eight poles, in case the poles of the rotating bodies 30 are disposed not to exactly face the opposite poles of the neighboring rotating bodies 30, and the rotating bodies 30 are fixed along its rotation axis 20 in the misaligned state with an angle of a predetermined range, the offset angle is defined as the misaligned angle of the rotating bodies 30. The offset angle is larger than 0 in a clockwise and counterclockwise direction, based on a state that the poles of the rotating bodies 30 are disposed to exactly face the opposite poles of the neighboring rotating bodies 30), and it is determined in such a manner that the circumferential component is maximized in accordance with a size of the rotating bodies 30 and the number of the poles of the rotating bodies 30.

One or more electromagnets 40 are disposed between the rotating bodies 30 (only three electromagnets are exemplary shown in this drawing), wherein the electromagnets 40 are magnetized to have two magnetic poles N and S as a current is applied to the coil 42 wound around a core 41. The electromagnets 40, disposed in a region influenced by a magnetic field, serve to drive the rotating bodies 30 by the component of the magnetic force generated by a circumferential component of the magnetic field of the rotating bodies 30. The core 41 is made of magnetizable metal, e.g., Fe, Ni, Co, Sm, Nd, or an alloy thereof.

The electromagnets 40 may be installed on an inner surface of the housing 10, and they may use partial regions of the housing 10 as electrodes.

In accordance with the first preferred embodiment, each of the electromagnets 40a, 40b and 40c is disposed between the rotating bodies 30 in a tangential direction of the rotating bodies 30 to have an influence on the circumferential component of the magnetic field, wherein one end of the electromagnet 40 are fixed on the housing 10. Although positions of the electromagnets fixed between the rotating bodies 30 are arbitrarily determined, it is, preferably, determined so that the electromagnets are disposed at positions where the magnetic force is greatest, and the rotating bodies 30 are rotated by controlling the poles of the electromagnets 40a, 40b and 40c successively.

Further, as shown in FIG. 2 describing a second preferred embodiment of the present invention, a plurality of electromagnets 40-1 and 40-2 is disposed between two neighboring rotating bodies 30-1, that is, in a region influenced by a magnetic field of the rotating bodies 30-1 in the circumferential direction (only two electromagnets are exemplary shown between the two neighboring rotating bodies 30-1 in this drawing).

Although the electromagnets 40-1 and 40-2 may be installed in arbitrary positions between the rotating bodies, it is preferable to dispose them in the tangential direction of the rotating bodies 30-1.

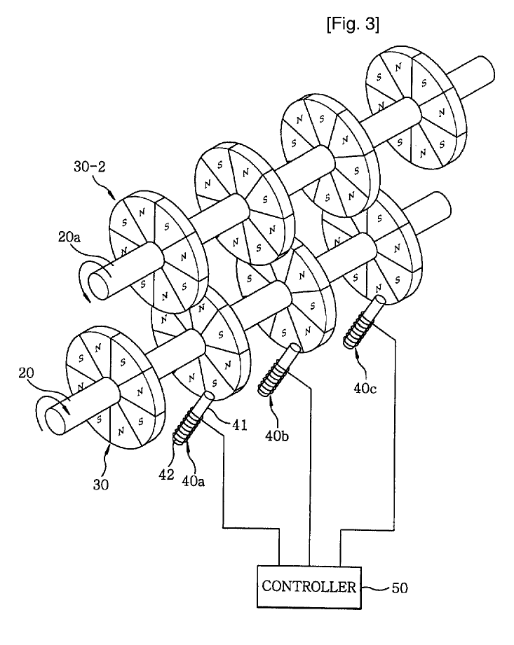

Referring to FIG. 3, there is shown a third preferred embodiment of the present invention.

As shown in FIG. 3, a plurality of rotating bodies 30 is disposed at an interval along the rotation axis 20. Each of the rotating bodies 30 is divided into a plurality of regions in a radial direction and each of the regions is magnetized to have either N or S poles in an alternative fashion or an intermittent fashion on the entire region or a partial region of the rotating bodies 30 facing each other. The regions at corresponding positions of the neighboring rotating bodies 30 are offset by a predetermined angle, to generate the component of the magnetic force in the circumferential direction from the magnetic force formed between the rotating bodies 30, wherein the poles of each of the rotating bodies 30 are disposed to face the opposite poles of the neighboring rotating bodies 30.

A rotation axis 20a provided with a rotating bodies 30-2 is installed near the rotation axis 20. That is, another rotation assembly is installed so that the rotating bodies 30-2 of another rotation axis 20a are disposed between the rotating bodies 30 and the driven rotation assembly is interlockingly rotated with a rotation of the driving rotation assembly to which the driving force is delivered, in the opposite direction.

The rotating bodies 30-2 of the rotation axis 20a may have the different number of the magnetic poles from that of the driving rotating bodies 30. In this case, the rotation assembly may be driven with a different speed of a rotation from that of the driving rotation assembly, and thus the speed of the rotation of the driven rotation assembly can be either increased or decreased.

Further, the two rotation assemblies can be isolated each other by an object through which the magnetic force lines pass so that the two rotation assemblies rotate interlockingly with each other while systems respectively including the rotation assemblies, are not mixed.

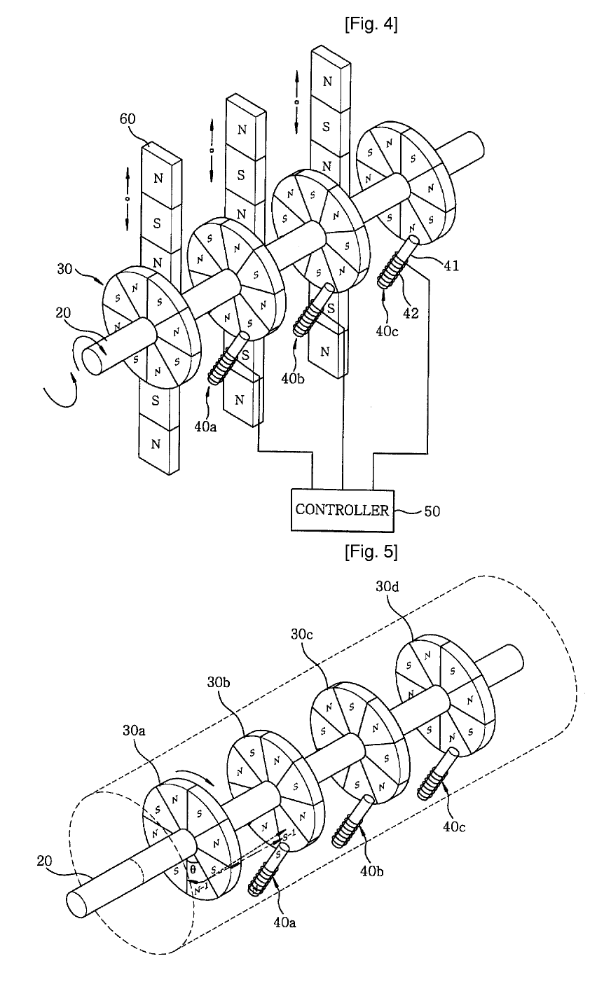

FIG. 4 illustrates a fourth preferred embodiment. The fourth preferred embodiment is identical to the third embodiment excepting the replacement of the rotating bodies 30-2 by one or more linear structures 60; and therefore, a detailed description thereof will be omitted for the sake of simple explanation.

The linear structure 60 includes a magnetized material of an arbitrary volume attached to a partial region of the linear structure, and is adjacently disposed to be perpendicular to the direction of the rotation axis in the tangential direction of the rotating bodies in the region influenced by the magnetic field of the adjacent driving rotating bodies 30. More specifically, the linear structure 60 has a predetermined length and is magnetized to have the N and S poles alternately at constant intervals for a rectilinear movement. In this state, in case the rotating bodies 30 are driven, the linear structure 60 can interlockingly move linearly without a contact. That is, in case the axis of the driving rotating bodies is fixed, and the driving rotating bodies rotate, the linear structure in the region influenced by the magnetic field moves linearly. In case the linear structure 60 is curve-shaped, a curve movement is possible. On the contrary, in case the linear structure 60 having the magnetized N and S poles alternately is fixed, while rendering the axis of the driving rotating bodies 30 moved, the driving rotating bodies 30 in the region influenced by the magnetic field of the linear structure 60 can be used as a transfer unit by the rotation of the rotating bodies 30.

A controller 50 is employed for controlling the electromagnets 40. The controller 50 provides the rotational force to the rotating bodies 30 by successively magnetizing each electromagnet 40 at a predetermined timing by a current application.

Further, with a change of a polarity of the electromagnets 40 by the controller 50, the rotating direction of the rotating bodies 30 is changed accordingly, and thus a positive and negative rotation of the magnetic motor is possible.

Hereinafter, it will be described an operation of the magnetic motor in accordance with the present invention configured as described above.

First, the first preferred embodiment will be described referring to FIG. 5. In case that the offset angle of the rotating bodies 30 is 0a direction of magnetic force lines is shown as a dotted arrow parallel to the rotation axis 20. On the contrary, if there is provided the offset angle, the direction of the magnetic force lines is shown as a dashed dotted arrow because the pole N−1 of the rotating body 30a is not disposed to exactly face the S−1 pole of the neighboring rotating body 30b. At this time, at one end of the dashed dotted arrow started from N−1, a component of the magnetic force is generated to rotate the rotating body clockwise as shown by a solid arrow.

Further, the electromagnet 40a disposed in the region influenced by the magnetic field as shown in dotted lines in the tangential direction is magnetized to have N and S poles by the power application of the controller 50, wherein the N pole is disposed between the rotating bodies 30a and 30b.

Therefore, a repulsive force of the N pole of the electromagnet 40a rotates the N−1 of the rotating body 30a clockwise, and thus the rotation axis 20 is rotated clockwise.

In case the polarity of the electromagnet 40a is changed and thus the S pole is disposed between the rotating bodies 30a and 30b, the N−1 of the rotating body 30a is rotated counterclockwise by an attractive force of the S pole of the electromagnet 40a, and thus the rotating body 30a are rotated counterclockwise with the rotation axis 20.

When an angle θ is defined as the angle corresponding to an individual pole region formed on the surface of the rotating body, the rotating body 30a is rotated to a position where the repulsive force is 0, i.e., approximately by an angle θ. After the rotating body 30a is rotated by the angle θ, it is additionally rotated by an inertia in successive rotations of the rotating body. Therefore, the rotation angle of the rotating body 30a can be controlled by a winding of the electromagnets 40 or the like. Further, the remaining three rotating bodies 30b, 30c and 30d connected to the rotation axis 20 are also provided with the rotational force corresponding to the angle θ, while the other two electromagnets 40b and 40c are not magnetized at present.

On the other hand, in accordance with the rotated angular position of the rotating body 30a, the rotated angular position of the rotating body 30a, the controller 50 switches off the current to the first electromagnet 40a and applies a power to a following electromagnet 40b.

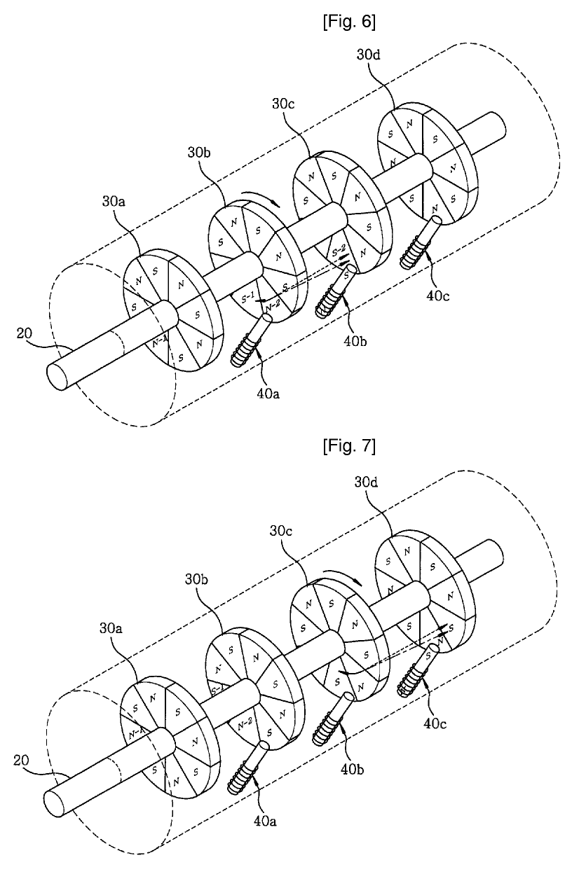

Referring to FIG. 6, after the rotating bodies are rotated by the angle θ corresponding to an individual pole region formed on the surface of the rotating body, S−2 of the rotating body 30c is disposed to face N−2 of the rotating body 30b with the electromagnet 40b therebetween. Herein, a component of the magnetic force is generated to rotate the rotating body clockwise as shown by a solid arrow as similarly as the N−1 and the S−1 in FIG. 5, and the component successively rotates the rotating bodies 30 clockwise by a repulsive force of N−2 when applying the current to the second electromagnet 40b.

Subsequently, as shown in FIG. 7, the rotating bodies 30c and 30d also rotate interlockingly.

In this manner, the rotation axis 20 is successively driven stably.

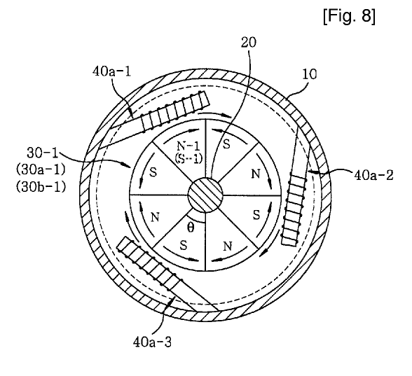

FIG. 8 describes an operation of the second preferred embodiment. As indicated by solid arrows in FIG. 8, a component of the magnetic force is generated between the N−1 of the rotating body 30a-1 and the S−1 of the rotating body 30b-1 facing each other in the misaligned state.

An electromagnet 40a-1 is disposed in a region influenced by the magnetic field shown in a dotted circle and magnetized to be a N pole. Accordingly, a magnetic force component from the N−1 of the rotating body 30a-1 becomes a repulsive force to an N pole of the electromagnet 40a-1, and thus the rotating body 30a-1 is rotated clockwise with the rotation axis 20.

In case the polarity of the electromagnet 40a-1 is changed, the S pole is disposed between the rotating bodies 30a-1 and 30b-1. At this time, the N−1 of the rotating body 30a-1 is rotated counterclockwise by an attractive force of the S pole of the electromagnet 40a-1 with the rotation axis 20.

Herein, the rotating bodies 30-1 are approximately rotated to a position where the repulsive force is 0, i.e., by an angle θ corresponding to an individual pole region formed on the surface of the rotating body. After the rotating body 30a is rotated by the angle θ, it is additionally rotated by an inertia in successive rotations. Therefore, the rotation angle of the rotating body 30-1 can be controlled by a winding of the electromagnets 40a or the like. The other two electromagnets 40a-2 and 40a-3 are not magnetized at present.

On the other hand, in accordance with the rotated angular position of the rotating body 30a-1, the controller 50 switches off the current to the first electromagnet 40a-1 and applies a power to the second electromagnet 40a-2.

In this manner, if the power is applied to the electromagnets 40a-2 and 40a-3 successively in the circumferential direction, each of the rotating bodies 30-1 is successively rotated clockwise or counterclockwise pursuant to a change of the polarities of the electromagnets.

On the other hand, in accordance with the third preferred embodiment, a rotating bodies 30-2 of the rotation axis 20a are disposed between the rotating bodies 30 driven in the same manner as those of the first preferred embodiment, and thus, the rotating bodies 30-2 are rotated counterclockwise when the rotating bodies 30 are rotated clockwise, and the rotating bodies 30-2 are rotated clockwise when the rotating bodies 30 are rotated counterclockwise because a rotational force of the rotating bodies 30 influences the rotating bodies 30-2 disposed in the region influenced by the magnetic field of the rotating bodies 30.

Therefore, the third preferred embodiment can be used as a power in case the two or more rotation axes are necessary.

Further, in accordance with the fourth preferred embodiment, in case a component of the magnetic force generated in accordance with the rotation of the rotating bodies 30 is applied to the one or more linear structures 60 disposed to be perpendicular to the direction of the rotation axis 20 in the tangential direction of the shown rotating bodies in the region influenced by the magnetic field of the one or more adjacent rotating bodies 30, lines of the component of the magnetic force overlaps with the N and S poles of the linear structure 60. Accordingly, the linear structure 60 moves linearly by repulsive and attractive forces. That is, in case the axis of the driving rotating bodies are fixed, as the rotating bodies rotate, the linear structure in the region influenced by the magnetic field moves linearly. Further, the linear structure 60 having a pre-determined length is repeatedly moved in a rectilinear movement within the pre-determined length of the linear structure 60 in the manner that after the linear structure 60 is moved linearly, the rotating bodies 30 are rotated in the opposite direction. On the contrary, in case the linear structure 60 is fixed, and the axis of the rotating bodies 30 is not fixed, the rotating bodies 30 can be used as a transfer unit.

Therefore, the rotating bodies can be used as a transfer unit which requires the rectilinear movement such as an elevator, a train running on a railroad or a door opening and closing unit. That is, in case the axis of the driving rotating bodies is fixed on a wall, and the rotating bodies are rotated, the linear structure moves linearly in accordance with the rotation of the rotating bodies, and thus the elevator can move vertically in the manner that the linear structure is fixed on a wall of the elevator and the rotating bodies are rotated. On the contrary, in case the driving rotating bodies are rotated in the state the linear structure is fixed, the rotating bodies move along the linear structure. For example, the fixed linear structure functions as the railroad, and the axis of the driving rotating bodies functions as wheels of the train in case of the train running on the railroad, wherein the axis of the driving rotating bodies is fixed on the train.

Although four rotating bodies are illustrated along the rotation axis 20 in FIGS. 1 to 7, to manufacture a smaller-sized or a larger-sized motor, the smaller or larger number of the rotating bodies may be disposed when necessary.

Further, in accordance with the preferred embodiments, the controller 50 may include a detecting unit for detecting rotated positions of the rotating bodies 30. The detecting unit sends signals to the controller 50, and accordingly, the controller 50 provides the rotational force to the rotating bodies 30 by successively magnetizing each electromagnet 40 at a predetermined timing by a current application.

Further, in accordance with the preferred embodiments, the two or more electromagnets can be magnetized together by each set of two or more to increase the rotational force. If the electromagnets do not exist in the same plane, and there is provided an offset angle in a position of the electromagnets disposed between the rotating bodies so that they are disposed at correspondingly predetermined position of the poles of the rotating bodies, the rotational force can be increased. At this time, the neighboring electromagnets have to be magnetized to have opposite poles.

While the invention has been shown and described with respect to the preferred embodiments, it will be understood by those skilled in the art that various changes and modifications may be made without departing from the scope of the invention as defined in the following claims.

1. A magnetic motor comprising:
a rotation assembly having a rotation axis and a plurality of rotating bodies fixedly installed at an interval along the rotation axis and magnetized to have multipole;
one or more electromagnets, installed in a region influenced by a magnetic field derived from the adjacent rotating bodies, whereby the rotation assembly is driven by magnetic repulsive and attractive forces between the rotating bodies and the one or more electromagnets; and
a controller for sequentially controlling magnetization of the one or more electromagnets.

2. The magnetic motor of claim 1, wherein each of the rotating bodies is divided into a plurality of regions in a radial direction, each region being magnetized with a particular polarity, and wherein the regions at corresponding positions of the neighboring bodies are offset by an arbitrarily predetermined angle of up to a right angle, to generate the component of the magnetic force in a circumferential direction of the rotating bodies.

3. The magnetic motor of claim 2, wherein the region is magnetized to have either N or S poles in an alternative fashion or an intermittent fashion.

4. The magnetic motor of claim 1, wherein the rotating bodies are plates which are disk-shaped, ellipse-shaped, polygon-shaped, saw tooth-shaped or indeterminate shaped, or a zigzag shaped structure or a shape that a plurality of plates having different sizes and shapes is laminated.

5. The magnetic motor of claim 1, wherein one or more electromagnets are disposed between the rotating bodies to have an influence on the circumferential component of the magnetic field, wherein the one or more of electromagnets are disposed between a pair of the rotating bodies in a circumferential direction.

6. The magnetic motor of claim 5, wherein the one or more electromagnets is disposed in a tangential direction of the rotating bodies.

7. The magnetic motor of claim 1, wherein the electromagnet has a core and a coil wound around thereof to which current is applied to magnetize the electromagnet under the control of the controller.

8. The magnetic motor of claim 7, wherein the core is made of a magnetizable metal, wherein the magnetizable metal includes Fe, Ni, Co, Sm, Nd, or an alloy thereof.

9. The magnetic motor of claim 7, wherein a polarity of the electromagnet is changed by a control of the controller so that a rotating direction of the rotating bodies is changed.

10. The magnetic motor of claim 1, further comprising another rotation assembly adjacently installed in a region influenced by a magnetic field of the rotation assembly,
wherein the driven rotation assembly has a rotation axis and a plurality of rotating bodies fixedly installed at an interval along the rotation axis and magnetized to have multipole; and is interlockingly rotated with a rotation of the driving rotation assembly in the opposite direction, and the number of rotations of the driven rotating assembly can be arbitrarily controlled equally to or differently from that of the driving rotating assembly.

11. The magnetic motor of claim 1, further comprising one or more linear structures having divided regions, each region being magnetized to have the N and S poles alternately at constant intervals, wherein the one or more linear structures are adjacently disposed across the rotation axis in the tangential direction of the rotating bodies in the region influenced by the magnetic field of the adjacent driving rotating bodies,
wherein, as the rotating bodies is rotated, the linear structure achieves a repeated rectilinear movement within a length of the linear structure or a repeated curve movement within a constant range in case the linear structure is curve-shaped, or on the contrary, the rotating bodies whose axis is not fixed is moved in a region influenced by a magnetic field of the fixed linear structure.

12. The magnetic motor of claim 1, wherein the electromagnets can be magnetized by one or each set of two or more.
